(19) United States
(12) Patent Application Publication
(10) Pub. No.: US 2026/0117811 A1
(43) Pub. Date: Apr. 30, 2026

(54) CONNECTION STRUCTURE FOR ADJUSTABLE HEADBOARD BRACKET, AND BED FRAME

(71) Applicant: FLEXISPOT INC., Irvine, CA (US)

(72) Inventors: Lehong XIANG, Irvine, CA (US); Haojie ZHENG, Irvine, CA (US); Xiaojia CHEN, Irvine, CA (US); Nan HONG, Quzhou (CN); Shangman JI, Irvine, CA (US); Zhengjun CHEN, Irvine, CA (US); Lili WANG, Irvine, CA (US)

(21) Appl. No.: 19/420,617

(22) Filed: Dec. 15, 2025

Related U.S. Application Data
(63) Continuation of application No. 19/272,735, filed on Jul. 17, 2025.

(30) Foreign Application Priority Data
Sep. 30, 2024 (CN) 202411378785.6
Sep. 30, 2024 (CN) 202422406756.8
Jan. 8, 2025 (CN) 202520040052.5

(51) Int. Cl. F16B 12/56; A47C 19/02; A47C 19/04

(52) U.S. Cl. CPC F16B 12/56; A47C 19/022; A47C 19/04

(57) ABSTRACT

A connection structure for an adjustable headboard bracket includes a connection frame body, a supporting arm, a second adjusting member, and a limiting member.

### CROSS-REFERENCE TO RELATED APPLICATIONS

This application is a Continuation of U.S. patent application Ser. No. 19/272,735, filed Jul. 17, 2025, which claims priority to and benefit of Chinese Patent Application No. 202520040052.5, filed Jan. 8, 2025, Chinese Patent Application No. 202411378785.6, filed Sep. 30, 2024, and Chinese Patent Application No. 202422406756.8, filed Sep. 30, 2024 which are incorporated herein in their entirety by reference.

### TECHNICAL FIELD

The present application relates to the field of bed frame, and more specifically, to a connection structure for an adjustable headboard bracket and a bed frame.

### BACKGROUND

In the furniture industry, modular furniture is gaining popularity in order to respond to user needs more quickly. By rapidly assembling components to form a frame structure and supplementing it with other supporting structures, quick-assembled bookshelves, storage shelves, or bed frames can meet users' needs for quick use.

In the prior art, an adjustable headboard bracket is known, which is designed to be used in combination with a user's existing bed frame. This headboard bracket typically functions as an adjustable back-support structure, allowing the inclination angle of the backboard to be varied according to user needs, thereby providing a certain degree of support. However, when such an adjustable headboard bracket is used with bed frames of different models or structural configurations, a relatively large gap often appears between the two components, and the size of this gap may vary from one bed frame to another. Such variations may adversely affect the stability of support and the overall user experience. Therefore, there is a need for a connection structure capable of compensating for this gap, so that the headboard bracket can be mounted to the bed frame in a more flexible, more secure, and more reliable manner.

However, the connection structure of the adjustable headboard bracket in existing technologies is complex and inconvenient to install and adjust.

### SUMMARY

The present application provides a connection structure for an adjustable headboard bracket, including:
a connection frame body, wherein a supporting arm mounting hole and at least one adjusting hole are provided on the connection frame body;
a supporting arm, wherein the supporting arm is configured to be inserted into the supporting arm mounting hole, and the supporting arm is detachably connected to the connection frame body;
a second adjusting member, wherein the second adjusting member is connected to the connection frame body, and the second adjusting member is provided with at least one second fixing hole;
a limiting member, wherein the limiting member is disposed within the adjusting hole, the limiting member is configured to engage with the second fixing hole and abut against the supporting arm.

In some embodiments, the supporting arm includes a first end configured to connect to a bracket of a bed frame and a second end configured to connect to the connection frame body; the supporting arm further includes a connection portion; and the connection portion is located at the first end of the supporting arm.

In some embodiments, the connection portion includes:
an engaging member disposed at the first end of the supporting arm;
a supporting member disposed on the engaging member.

In some embodiments, the engaging member has a bending structure; the bending structure forms an engaging opening, and the engaging opening is configured to face the ground; the engaging opening is configured to engage with the bracket of the bed frame.

In some embodiments, the engaging member and the supporting member are integrally formed.

In some embodiments, the supporting arm further includes a first adjusting member, and the first adjusting member is provided with a first fixing hole; the limiting member is configured to engage with the first fixing hole.

In some embodiments, the connection frame body includes two main rods and at least one auxiliary rod; the auxiliary rod is disposed between the two main rods and is fixedly connected to the two main rods; two supporting arm mounting holes are respectively disposed at two ends of each main rod.

In some embodiments, an angle between the main rod and the auxiliary rod is substantially 90 degrees.

The present application provides a bed frame, including:
the connection structure for an adjustable headboard bracket according to any embodiment above;
an adjustable headboard bracket connected to the supporting arm disposed at one end of the connection structure; and
a second bracket connected to the supporting arm disposed at another end of the connection structure;
where the adjustable headboard bracket is detachably connected to the second bracket via the connection structure.

In some embodiments, the adjustable headboard bracket is connected to the supporting arm via the engaging opening of the engaging member of the supporting arm, and the second bracket is connected to the support arm via the engaging opening of the engaging member of the supporting arm.

Other features and advantages of the present application will become apparent from the following detailed description of exemplary embodiments of the present application with reference to the drawings.

### BRIEF DESCRIPTION OF DRAWINGS

FIG. 1 is a schematic structural diagram of a connection structure for an adjustable headboard bracket according to one embodiment of the present application.

FIG. 2 is a schematic structural diagram of a connection frame body according to one embodiment of the present application.

FIG. 3 is a schematic structural diagram of a supporting arm according to one embodiment of the present application.

FIG. 4 is a schematic structural diagram of a bed frame according to one embodiment of the present application.

FIG. 5 is an enlarged diagram of portion A in FIG. 4.

### DESCRIPTION OF EMBODIMENTS

Those skilled in the art should understand that the embodiments and the implementations are merely used to explain the technical principles of the technical solutions of the present application and are not intended to limit the scope of protection of the technical solutions of the present application. Those skilled in the art may adjust them as needed to suit specific application scenarios.

In the description of the embodiments of the present application, it should be noted that, unless otherwise specified or limited, the terms “connected” and “connection” should be understood in a broad sense. For example, they can refer to fixed connections, detachable connections, movable connections, or integral connections; they can refer to mechanical connections or electrical connections; they can refer to direct connections or indirect connections through an intermediate medium. Those skilled in the art will understand the specific meanings of the above terms in the embodiments of the present application based on the specific circumstances.

In the embodiments of the present application, unless otherwise expressly specified or limited, a first feature being “above” or “below” a second feature may mean that the first and second features can be in direct contact, or that the first and second features can be in indirect contact through an intermediate medium. Furthermore, a first feature being “above”, “on” and “over” a second feature may mean that the first feature is directly above or obliquely above the second feature, or may simply mean that the first feature is higher in level than the second feature. A first feature being “below”, “beneath” and “under” a second feature may mean that the first feature is directly below or obliquely below the second feature, or may simply mean that the first feature is lower in level than the second feature.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous. The terms “first”, “second”, “third”, and the like are used only as labels, not to the number or the importance of objects thereof.

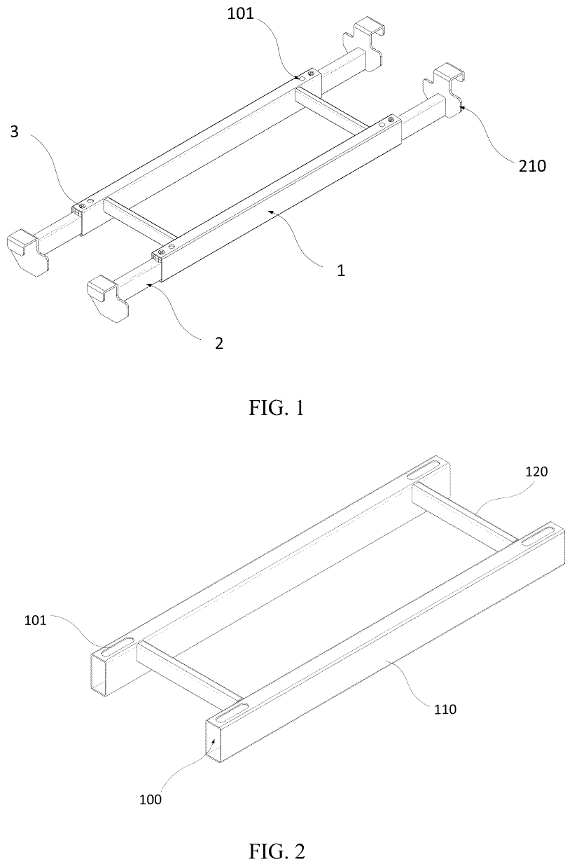

As shown in FIGS. 1, 2, and 3, the present application provides a connection structure for an adjustable headboard bracket, including a connection frame body 1, a supporting arm 2, a second adjusting member 102, and a limiting member 3. A supporting arm mounting hole 100 and at least one adjusting hole 101 are disposed at the connection frame body 1. The supporting arm 2 is configured to be inserted into the supporting arm mounting hole 100, and the supporting arm 2 is detachably connected to the connection frame body 1. The second adjusting member 102 is fixedly connected to the connection frame body 1, and the second adjusting member 102 is provided with at least one second fixing hole 103. The limiting member 3 is disposed within the adjusting hole 101, and the limiting member 3 is configured to engage with the second fixing hole 103 and abut against the supporting arm 2.

In some embodiments, the at least adjusting hole 101 may be a plurality of spaced-out circular holes or one or more elongated slotted holes.

The supporting arm 2 is configured to connect the adjustable headboard bracket to the rest part of the bed frame. In some embodiments, at least one supporting arm 2 is connected to at least one of the two brackets of the bed frame, and then it can be connected to the connection frame body 1, thus achieving the connection between the two brackets of the bed frame. Specifically, the flexibility of the connection structure may be achieved by one or more adjustable connectors (namely the supporting arm in this application) disposed at its one side and one or more fixed connectors disposed at the other side, or may be achieved by one or more adjustable connectors disposed at its both sides. The limiting member 3 engages with the second fixing hole 103 on the second adjusting member 102 and abuts against the supporting arm 2, restricting the movement of the supporting arm 2 within the supporting arm mounting hole 100 and fixing the connection between the supporting arm 2 and the connection frame body 1. When the length of the connection structure needs adjustment, the limiting member 3 can be loosened, allowing the supporting arm 2 to move within the supporting arm mounting hole 100, thereby adjusting the length of the supporting arm extending beyond the supporting arm mounting hole 100. When the supporting arm 2 is adjusted to the expected length, the limiting member 3 can be tightened again, and it will abut against the supporting arm 2, thus fixing the position of the supporting arm 2.

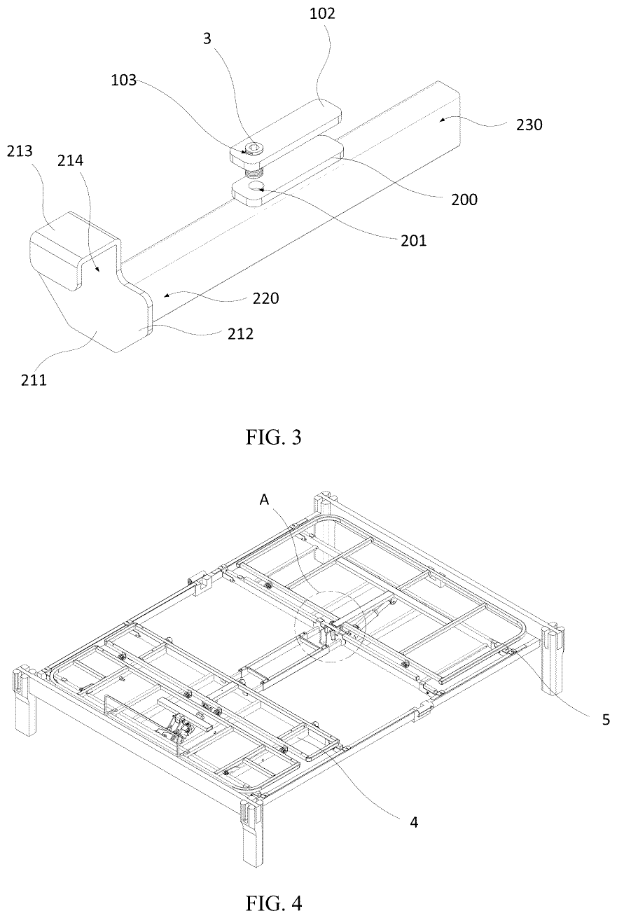

As shown in FIG. 3, the supporting arm 2 includes a first end 220 for connecting to a bracket of a bed frame and a second end 230 for connecting to the connection frame body 1. The supporting arm 2 further includes a connection portion 210. The connection portion 210 is located at the first end 220 of the supporting arm 2.

Specifically, the first end 220 of the supporting arm 2 is sleeved within the supporting arm mounting hole 100.

The connection portion 210 is configured to connect with the bracket of the bed frame, and the first end 220 is configured to engage with the supporting arm mounting hole 100.

The connection portion 210 includes an engaging member 211 and a supporting member 212. The engaging member 211 is disposed at the first end 220 of the supporting arm 2 and the supporting member 212 is disposed on the engaging member 211.

In some embodiments, the supporting member 212 is provided with cut-offs on the side away from the engaging member 211, which can reduce the stress at the connection between the supporting member 212 and the engaging member 211 and can make the overall structure of the connection portion 210 more stable and less prone to deformation.

The engaging member 211 is configured to engage with the bracket of the bed frame, and the supporting member 212 can provide a supporting force perpendicular to the engaging direction for the bracket of the bed frame, so as to prevent the brackets of the bed frame from deforming during connection and use.

As shown in FIG. 3, the engaging member 211 has a bending structure 213 and the bending structure 213 forms an engaging opening 214, which faces the ground. The engaging opening 214 is configured to engage with the bracket of the bed frame.

The bracket of the bed frame is engaged into the engaging opening 214 to achieve the connection(s) between the bracket(s) of the bed frame and the supporting arm 2.

The engaging member 211 and the supporting member 212 are integrally formed.

In some embodiments, the engaging member 211 and the supporting member 212 may be integrally formed by stamping technology.

The member integrally formed can eliminate the wear and tear on the engaging member 211 and the supporting member 212 caused by welding, making the connection between the engaging member 211 and the supporting member 212 more secure, and also ensuring the overall structural strength of the connection portion 210.

As shown in FIGS. 1 and 3, the supporting arm 2 further includes a first adjusting member 200, and the first adjusting member 200 is provided with a first fixing hole 201. The limiting member 3 is configured to engage with the first fixing hole 201.

Specifically, the first fixing hole 201 may be a smooth hole.

The limiting member 3 can engage with the first adjusting hole 201 on the first adjusting member 200 to further limit the movement of the supporting arm 2 in the supporting arm mounting hole 100. Even if the engagement between the limiting member 3 and the supporting arm 2 is loosened due to wear and tear from long-term use, the supporting arm 2 will not move within the supporting arm mounting hole 100, thereby achieving further fixation of the position of the supporting arm 2. The first adjusting member 200 can provide further support and protection for the limiting member 3 and extend the service life of the limiting member 3.

As shown in FIG. 2, the connection frame body 1 includes two or more main rods 110 and at least one auxiliary rod 120. At least one auxiliary rod 120 is disposed between every two main rods 110 and is fixedly connected to the two main rods 110. Two supporting arm mounting holes 100 are respectively disposed at two ends of each main rod 110. In some embodiments, the connection frame body 1 may include only one main rod.

The main rod 110 is configured to engage with the supporting arm 2. The auxiliary rod 120 connects to the main rods 110, increasing the structural strength of the connection frame body 1, so that the connection frame body 1 can effectively support the connection between brackets of the bed frame.

An angle between the main rod 110 and the auxiliary rod 120 may be 90 degrees. In some embodiments, the main rod 110 is substantially perpendicular to the auxiliary rod 120.

A 90-degree connection makes the connection between the main rod 110 and the auxiliary rod 120 more stable and provides better support.

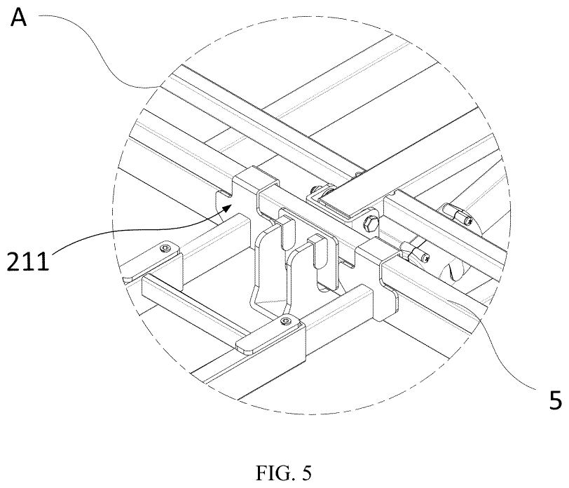

As shown in FIGS. 4 and 5, the present application provides a bed frame, including the connection structure for an adjustable headboard bracket of any embodiment above, an adjustable headboard bracket 5 and a second bracket 4. The adjustable headboard bracket 5 is connected to the supporting arm(s) 2 disposed at one end of the connection structure. The second bracket 4 is connected to the supporting arm(s) 2 disposed at the other end of the connection structure. The adjustable headboard bracket 5 is detachably connected to the second bracket 4 via one or more connection structures.

The adjustable headboard bracket 5 and the second bracket 4 are connected together by the connection structure, and the distance between the adjustable headboard bracket 5 and the second bracket 4 can be adjusted to adapt to the size of the rest parts of the bed frame that the user already has.

The connection structure includes the engaging member. The adjustable headboard bracket 5 is connected to the supporting arm(s) 2 via the engaging opening(s) 214 of the engaging member(s) 211 of the supporting arm(s) 2, and the second bracket 4 is connected to the supporting arm(s) 2 via the engaging opening(s) 214 of the engaging member(s) 211 of the supporting arm(s) 2.

The engaging member 211 achieves the engagement between the adjustable headboard bracket 5 and the supporting arm 2, and the engagement between the second bracket 4 and the supporting arm 2.

The adjustable headboard bracket of the present application includes a stationary bracket, a movable bracket, a linear actuator, at least one connecting member and a guiding mechanism. The stationary bracket includes at least one sheet metal member, and the sheet metal member is configured to be arranged along a width direction or a length direction of the adjustable headboard bracket. The movable bracket is rotatably connected to the stationary bracket. The linear actuator is configured to drive the movable bracket to rotate relative to the stationary bracket, and the linear actuator connects the movable bracket and the stationary bracket. The connecting member includes a connecting portion and a mounting portion. The mounting portion is connected to a first end of the connecting portion and configured to be mounted to an existing bed frame, and a second end of the connecting portion is slidably connected to the sheet metal member along a length direction of the sheet metal member. The connecting portion is configured to adjust a distance between the mounting portion and the sheet metal member. The guiding mechanism is connected between the connecting portion and the sheet metal member, and the connecting portion and the sheet metal member are configured to rotate relative to each other around the guiding mechanism.

In some embodiments, the adjustable headboard bracket further includes two supporting portions, wherein the two supporting portions are arranged respectively on an upper side and a lower side of the sheet metal member along the length direction of the sheet metal member, the two supporting portions are connected to one of the connecting portion and the sheet metal member, and the two supporting portions are configured to abut against a left one of the connecting portion and the sheet metal member when a gravity of the adjustable headboard bracket is loaded onto the existing bed frame.

In some embodiments, the guiding mechanism is arranged in a horizontal direction, the guiding mechanism includes a locking rod assembly connected to the connecting portion, and a guiding hole disposed at the sheet metal member extends along a length direction of the sheet metal member, and the locking rod assembly passes through the guiding hole.

In some embodiments, the guiding mechanism is arranged in a horizontal direction, the guiding mechanism includes a locking rod assembly connected to the sheet metal member, and a guiding hole disposed at the connecting portion extends along a length direction of the connecting portion, and the locking rod assembly passes through the guiding hole.

In some embodiments, the connecting portion is slidably mounted around a free end of the sheet metal member, the two supporting portions include a first supporting plate and a second supporting plate, the first supporting plate is connected to the second end of the connecting portion and the first supporting plate is in a sliding cooperation with a top of the sheet metal member, and the second supporting plate is connected to the first end of the connecting portion and the second supporting plate is in a sliding cooperation with a bottom of the sheet metal member.

In some embodiments, the first supporting plate, the second supporting plate and the connecting portion are integrally formed by a bent metal plate.

In some embodiments, the connecting portion is slidably sleeved in an internal cavity of the sheet metal member, the two supporting portions include a first supporting block and a second supporting block, the first supporting block is connected to and protrudes downwards from a bottom of the second end of the connecting portion, the first supporting block is in a sliding cooperation with internal walls of the sheet metal member, the second supporting block is connected to and protrudes upwards from a top of the first end of the connecting portion, the second supporting block is in a sliding cooperation with internal walls of the sheet metal member.

In some embodiments, the connecting portion is slidably sleeved in an internal cavity of the sheet metal member, the two supporting portions include a first supporting element and a second supporting element, the first supporting element is connected to and protrudes upwards from an internal bottom wall of the sheet metal member, the first supporting element is in a sliding cooperation with a bottom of the connecting portion, the second supporting element is connected to and protrudes downwards from an internal top wall of the sheet metal member, the second supporting element is in a sliding cooperation with a top of the connecting portion, and the first supporting element is further away from the mounting portion than the second supporting element.

In some embodiments, the sheet metal member is a hollow tube with a circular or a square cross section; or the sheet metal member is a groove-shaped member.

In some embodiments, the adjustable headboard bracket includes a plurality of sheet metal members, and two connecting members are respectively arranged on opposite sides along a length direction of each sheet metal member.

In some embodiments, a connecting end of the stationary bracket is connected to a supporting frame extending downwards and inclined towards a free end of the stationary bracket, and a mounting point is formed on the supporting frame; the linear actuator includes an actuator body and a driving end that reciprocates axially relative to the actuator body, the driving end is rotatably connected to one of the movable bracket and the mounting point, and the actuator body is rotatably connected to a left one of the movable bracket and the mounting point.

In the description of the embodiments of the present application, it should be noted that in the description of the present application, terms such as “inside” and “outside” indicating directions or positional relationships are based on the directions or positional relationships shown in the accompanying drawings. This is only for the convenience of description and does not indicate or imply that the device or component must have a specific orientation, be constructed and operated in a specific orientation. Therefore, it cannot be understood as a limitation on the present application.

In the description of the present application, the description with reference to the terms “one embodiment”, “some embodiments”, “in one implementation”, “for example”, or “some implementations” means that the specific features, mechanisms, materials or characteristics described in conjunction with the embodiment or example are included in at least one embodiment or example of the present application. In this specification, the schematic representations of the above terms do not necessarily refer to the same embodiment or example. Moreover, the specific features, mechanisms, materials or characteristics described can be combined in a suitable manner in any one or more embodiments or examples. In addition, those skilled in the art can combine different embodiments or examples described in this specification and the features of different embodiments or examples, unless they are contradictory.

The above description is merely a specific embodiment of the present application, but the scope of protection of the present application is not limited thereto. Any changes or substitutions that can be easily conceived by a person skilled in the art within the technical scope disclosed in the present application should be included in the scope of protection of the present application. Therefore, the scope of protection of the present application should be based on the scope of protection of the claims.

What is claimed is:

1. A connection structure for an adjustable headboard bracket, comprising:
a connection frame body, wherein a supporting arm mounting hole and at least one adjusting hole are provided on the connection frame body;
a supporting arm, wherein the supporting arm is configured to be inserted into the supporting arm mounting hole, and the supporting arm is detachably connected to the connection frame body;
a second adjusting member, wherein the second adjusting member is connected to the connection frame body, and the second adjusting member is provided with at least one second fixing hole;
a limiting member, wherein the limiting member is disposed within the adjusting hole, the limiting member is configured to engage with the second fixing hole and abut against the supporting arm.

2. The connection structure according to claim 1, wherein the supporting arm comprises a first end configured to connect to a bracket of a bed frame and a second end configured to connect to the connection frame body;
the supporting arm further comprises a connection portion; and
the connection portion is located at the first end of the supporting arm.

3. The connection structure according to claim 2, wherein the connection portion comprises:
an engaging member disposed at the first end of the supporting arm;
a supporting member disposed on the engaging member.

4. The connection structure according to claim 3, wherein the engaging member has a bending structure;
the bending structure forms an engaging opening, and the engaging opening is configured to face the ground;
the engaging opening is configured to engage with the bracket of the bed frame.

5. The connection structure according to claim 4, wherein the engaging member and the supporting member are integrally formed.

6. The connection structure according to claim 1, wherein the supporting arm further comprises a first adjusting member, and the first adjusting member is provided with a first fixing hole;
the limiting member is configured to engage with the first fixing hole.

7. The connection structure according to claim 1, wherein the connection frame body comprises two main rods and at least one auxiliary rod;
the auxiliary rod is disposed between the two main rods and is fixedly connected to the two main rods;
two supporting arm mounting holes are respectively disposed at two ends of each main rod.

8. The connection structure according to claim 7, wherein an angle between the main rod and the auxiliary rod is substantially 90 degrees.

9. A bed frame, comprising:
the connection structure for an adjustable headboard bracket according to claim 3;
an adjustable headboard bracket connected to the supporting arm disposed at one end of the connection structure; and
a second bracket connected to the supporting arm disposed at another end of the connection structure;
wherein the adjustable headboard bracket is detachably connected to the second bracket via the connection structure.

10. The bed frame according to claim 9, wherein the adjustable headboard bracket is connected to the supporting arm via the engaging opening of the engaging member of the supporting arm, and the second bracket is connected to the supporting arm via the engaging opening of the engaging member of the supporting arm.
